(19) United States
(12) Patent Application Publication
(10) Pub. No.: US 2013/0055078 A1
(43) Pub. Date: Feb. 28, 2013

(54) SYSTEMS AND METHODS FOR IMPROVED NAVIGATION OF A MULTI-PAGE DISPLAY

(71) Applicants: Marni A. Berger, Belmont, CA (US); Ciara Peter, San Francisco, CA (US); Pratima Arora, Sunnyvale, CA (US); Anshu Agarwal, San Francisco, CA (US)

(72) Inventors: Marni A. Berger, Belmont, CA (US); Ciara Peter, San Francisco, CA (US); Pratima Arora, Sunnyvale, CA (US); Anshu Agarwal, San Francisco, CA (US)

(73) Assignee: salesforce.com, inc., San Francisco, CA (US)

(21) Appl. No.: 13/594,671

(22) Filed: Aug. 24, 2012

Related U.S. Application Data
(60) Provisional application No. 61/526,748, filed on Aug. 24, 2011.

(51) Int. Cl. G06F 17/00

(52) U.S. Cl. 715/273

(57) ABSTRACT

A user accesses various pages of a record over a network. The pages are displayed as a stack of pages. In an embodiment, the user can save a state of the stack so that the user can continue working at a later time right where the user left off. A list is stored that identifies the pages in the stack and an order in which the pages were last displayed. When the user is ready to resume working, the user is provided with an ordered stack of pages.

### CLAIM OF PRIORITY

This application claims the benefit of U.S. Provisional Patent Application 61/526,748 entitled SYSTEMS AND METHODS FOR IMPROVED NAVIGATION OF A MULTI-PAGE DISPLAY, by Marni A. Gasn, Ciara Peter, and Pratima Arora, filed Aug. 24, 2011 (Attorney Docket No. 741PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to computer systems and software, and, more particularly, to improved navigation of a multi-page display in an on-demand services environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Information is often organized as a tree of topics and subtopics. Users can obtain detailed information by drilling into or navigating to the lower levels of the tree. In some cases, a user may be working on a task and may be referencing information present on two or more levels of the tree. Unfortunately, it's hard to get through the day without being interrupted. For example, the user may be in the middle of working on an important business account or a new opportunity, but may be interrupted by a phone call, have to rush to catch a flight, or have to attend a meeting.

When the user is ready to resume working on the task, they must again drill through multiple levels in order to retrieve what they were working on before they were interrupted. This can be very time consuming and inefficient.

Therefore, there is a need for improved systems and techniques that allow users to quickly and easily save their work and resume working at a later time.

### BRIEF SUMMARY

In an embodiment, a user accesses various pages of a record over a network. The pages are displayed as a stack of pages. In an embodiment, the user can save a state of the stack so that the user can continue working at a later time right where the user left off. A list is stored that identifies the pages in the stack and an order in which the pages were last displayed. When the user is ready to resume working, the user is provided with an ordered stack of pages.

Disclosed herein is a system and method for improved navigation of a multi-page display. iOS devices, such as the Apple iPhone® and Apple iPad® are examples of devices having a touchscreen interface; however, while iOS devices are referenced herein, a person having ordinary skill in the art will appreciate that other devices may incorporate one or more embodiments of this disclosure. In addition, one or more examples disclosed herein reference interfacing a Salesforce® CRM application on a touchscreen device; however, other applications may also use one or more of embodiments of this disclosure.

In a touchscreen display, one way for multiple pages to be presented is by using two or more overlapping or overlaying pages. In this fashion, in order to access the information lower in the overlay stack, the user needs to swipe right. It is not uncommon for a user to view a common set of pages, often in the same order. However, repeating multiple swipes in order to view the same set of pages in a sequence is inefficient.

In an embodiment, viewing a sequence of pages or a set of pages can be saved or pre-fetched such that the desired set of pages is automatically called up and displayed to the user, thereby reducing the number of swipes required. The screenshots in this application illustrate one or more embodiments of this disclosure.

In a specific embodiment, a method includes saving a plurality of pages of a multi-page display for displaying using a single action.

In an embodiment and by way of example, a method for improved navigation of a multi-page display includes storing a set of records, each record including a set of pages for display at a client, receiving user access requests and transmitting, in response to the user access requests, corresponding pages of a record for display, receiving a user request to save a sequence of pages of the record that have been displayed, storing a list that identifies the pages in the sequence and an order in which the pages were displayed, receiving a user access request for the sequence, and transmitting, in response to the user access request for the sequence, the pages identified in the list, where the identified pages are to be displayed as a stack of pages, and the identified pages in the stack are positioned based on the order.

The client may be a first client and the transmitting the pages identified in the list may include transmitting the pages to a second client, different from the first client.

In an embodiment, pages in the stack that have been displayed earlier are positioned below pages in the stack that have been displayed later.

In another specific embodiment, the method further includes receiving second user access requests and transmitting, in response to the second user access requests, corresponding second pages of the record for display, receiving a second user request to save a second sequence of second pages of the record that have been displayed, storing a second list that identifies the second pages in the second sequence and a second order in which the second pages were displayed, receiving a second user access request for the second sequence, and transmitting, in response to the second user access request for the second sequence, the second pages identified in the second list, where the identified second pages are to be displayed as a second stack of pages, the identified second pages in the second stack are positioned based on the second order, the identified second pages are different from the identified pages, and the second order is different from the order.

In another specific embodiment, the record is a first record and the method further includes receiving second user access requests and transmitting, in response to the second user access requests, corresponding second pages of a second record, different from the first record, for display, receiving a second user request to save a second sequence of second pages of the second record that have been displayed, storing a second list that identifies the second pages in the second sequence and a second order in which the pages were displayed, receiving a second user access request for the second sequence, and transmitting, in response to the second user access request for the second sequence, the second pages identified in the second list, where the identified second pages are to be displayed as a second stack of pages, and the identified second pages in the second stack are positioned based on the second order.

While one or more implementations and techniques are described with reference to an embodiment in which an improved navigation of a multi-page display is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a block diagram of an example of an environment wherein an on-demand database service implementing an embodiment of improved navigation of a multi-page display might be used; and

FIG. 2 illustrates a block diagram of an embodiment of elements of FIG. 1 and various possible interconnections between these elements.

FIG. 3 illustrates a representative system that allows users to save their work and resume working at a later time in an embodiment;

FIG. 4 is an operational flow diagram illustrating a high level overview of a technique for saving work and resuming work at a later time in an embodiment;

FIG. 5 illustrates an example of a multi-page display in a first state in a first embodiment;

FIG. 6 illustrates an example of the multi-page display in a second state in the first embodiment;

FIG. 7 illustrates an example of the multi-page display in a third state in the first embodiment;

FIG. 8 illustrates an example of the multi-page display in a fourth state in the first embodiment;

FIG. 9 illustrates an example of the multi-page display in a fifth state in the first embodiment;

FIG. 10 illustrates an example of the multi-page display in a sixth state in the first embodiment;

FIG. 11 illustrates another example of a multi-page display in a first state in a second embodiment;

FIG. 12 illustrates another example of the multi-page display in a second state in the second embodiment;

FIG. 13 illustrates another example of the multi-page display in a third state in the second embodiment;

FIG. 14 illustrates another example of a multi-page display in a first state in a third embodiment;

FIG. 15 illustrates another example of a multi-page display in a second state in the third embodiment;

FIG. 16 illustrates another example of a multi-page display in a third state in the third embodiment;

FIG. 17 is another operation flow diagram illustrating another high level overview of a technique for saving work and resuming work at a later time in an embodiment;

FIG. 18 is a schematic example of a data structure;

FIG. 19 illustrates a screenshot of a display having a first page;

FIG. 20 illustrates a screenshot of the display having a second page;

FIG. 21 illustrates a screenshot of the display having a third page;

FIG. 22 illustrates a screenshot of the display having a fourth page;

FIG. 23 illustrates a screenshot of the display having a fifth page;

FIG. 24 illustrates a screenshot of the display having a sixth page;

FIG. 25 illustrates a screenshot of the display having a seventh page; and

FIG. 26 illustrates a screenshot of the display having an eighth page.

### DETAILED DESCRIPTION

Systems and methods are provided for improved navigation of a multi-page display. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

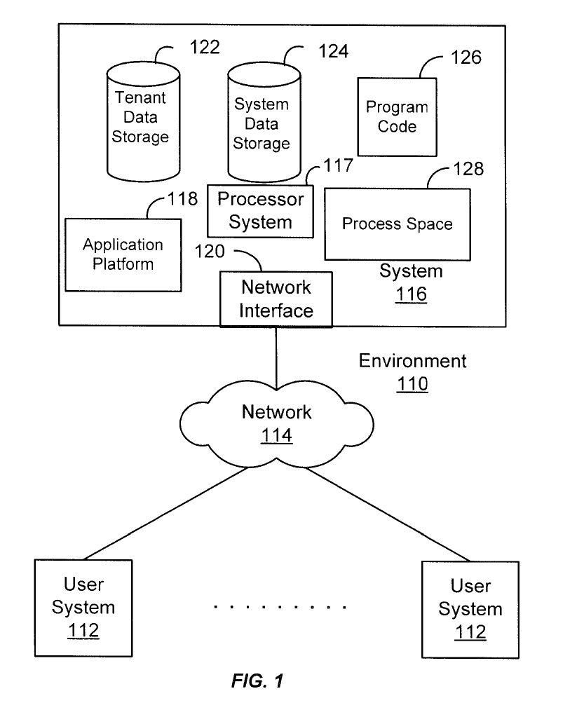

FIG. 1 illustrates a block diagram of an environment 110 wherein an on-demand database service implementing an embodiment of a system and method for improved navigation of a multi-page display might be used. Environment 110 may include user systems 112, network 114, system 116, processor system 117, application platform 118, network interface 120, tenant data storage 122, system data storage 124, program code 126, and process space 128. In other embodiments, environment 110 may not have all of the components listed and/or may have other elements instead of, or in addition to, those listed above.

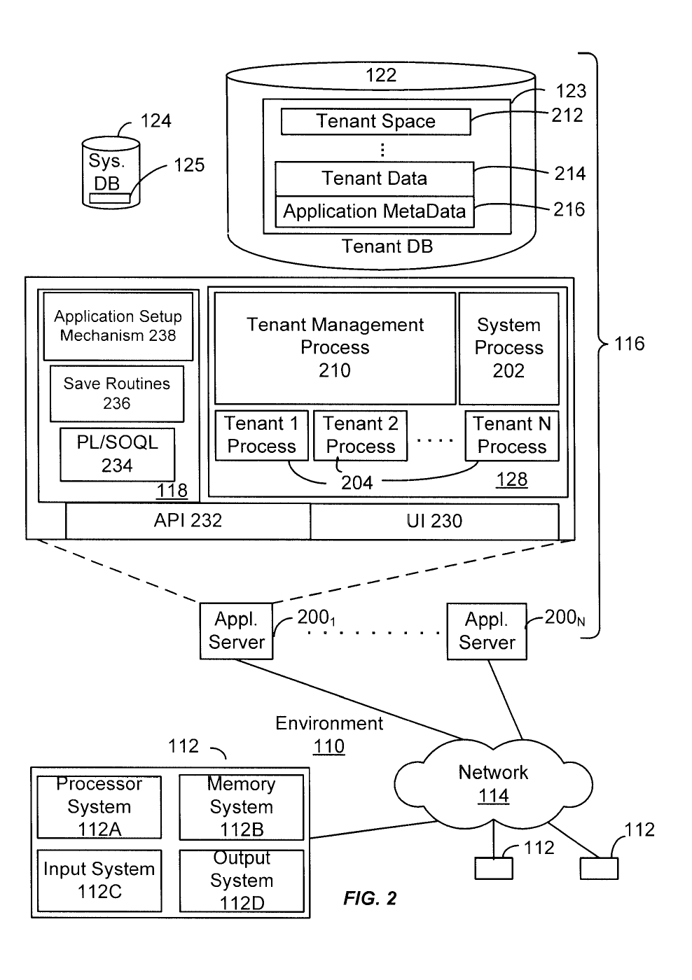

Environment 110 is an environment in which an on-demand database service exists. User system 112 may be any machine or system that is used by a user to access a database user system. For example, any of user systems 112 can be a handheld computing device, a mobile phone, a laptop computer, a work station, and/or a network of computing devices. As illustrated in FIG. 1 (and in more detail in FIG. 2) user systems 112 might interact via a network 114 with an on-demand database service, which is system 116.

An on-demand database service, such as system 116, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 116” and “system 116” will be used interchangeably herein. A database image may include one or more database objects. A relational database management system (RDMS) or the equivalent may execute storage and retrieval of information against the database object(s). Application platform 118 may be a framework that allows the applications of system 116 to run, such as the hardware and/or software, e.g., the operating system. In an embodiment, on-demand database service 116 may include an application platform 118 that enables creation, managing and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system to interact with system 116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 114 is any network or combination of networks of devices that communicate with one another. For example, network 114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 112 might communicate with system 116 using TCP/IP and, at a higher network level, use other common Internet protocols to communicate, such as HTTP, FTP, AFS, WAP, etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 116 implements applications other than, or in addition to, a CRM application. For example, system 116 may provide tenant access to multiple hosted (standard and custom) applications, including a CRM application. User (or third party developer) applications, which may or may not include CRM, may be supported by the application platform 118, which manages creation, storage of the applications into one or more database objects and executing of the applications in a virtual machine in the process space of the system 116.

One arrangement for elements of system 116 is shown in FIG. 1, including a network interface 120, application platform 118, tenant data storage 122 for tenant data 123, system data storage 124 for system data 125 accessible to system 116 and possibly multiple tenants, program code 126 for implementing various functions of system 116, and a process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each user system 112 could include a desktop personal computer, workstation, laptop, PDA, cell phone, or any wireless access protocol (WAP) enabled device or any other computing device capable of interfacing directly or indirectly to the Internet or other network connection. User system 112 typically runs an HTTP client, e.g., a browsing program, such as Microsoft's Internet Explorer browser, Google's Chrome browser, Mozilla's Firefox browser, Apple's Safari browser, Netscape's Navigator browser, Opera's browser, or a WAP-enabled browser in the case of a cell phone, smartphone, PDA or other wireless device, or the like, allowing a user (e.g., subscriber of the multi-tenant database system) of user system 112 to access, process and view information, pages and applications available to it from system 116 over network 114. Each user system 112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Oracle America, Inc.).

According to one embodiment, each system 116 is configured to provide webpages, forms, applications, data and media content to user (client) systems 112 to support the access by user systems 112 as tenants of system 116. As such, system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 110. However, in FIG. 2 elements of system 116 and various interconnections in an embodiment are further illustrated. FIG. 2 shows that user system 112 may include processor system 112A, memory system 112B, input system 112C, and output system 112D. FIG. 2 shows network 114 and system 116. FIG. 2 also shows that system 116 may include tenant data storage 122, tenant data 123, system data storage 124, system data 125, User Interface (UI) 230, Application Program Interface (API) 232, PL/SOQL 234, save routines 236, application setup mechanism 238, applications servers 200₁-200_{N}, system process space 202, tenant process spaces 204, tenant management process space 210, tenant storage area 212, user storage 214, and application metadata 216. In other embodiments, environment 110 may not have the same elements as those listed above and/or may have other elements instead of, or in addition to, those listed above.

User system 112, network 114, system 116, tenant data storage 122, and system data storage 124 were discussed above in FIG. 1. Regarding user system 112, processor system 112A may be any combination of one or more processors. Memory system 112B may be any combination of one or more memory devices, short term, and/or long term memory. Input system 112C may be any combination of input devices, such as one or more keyboards, mice, trackballs, scanners, cameras, and/or interfaces to networks. Output system 112D may be any combination of output devices, such as one or more monitors, printers, and/or interfaces to networks. As shown by FIG. 2, system 116 may include a network interface 120 (of FIG. 1) implemented as a set of HTTP application servers 200, an application platform 118, tenant data storage 122, and system data storage 124. Also shown is system process space 202, including individual tenant process spaces 204 and a tenant management process space 210. Each application server 200 may be configured to tenant data storage 122 and the tenant data 123 therein, and system data storage 124 and the system data 125 therein to serve requests of user systems 112. The tenant data 123 might be divided into individual tenant storage areas 212, which can be either a physical arrangement and/or a logical arrangement of data. Within each tenant storage area 212, user storage 214 and application metadata 216 might be similarly allocated for each user. For example, a copy of a user's most recently used (MRU) items might be stored to user storage 214. Similarly, a copy of MRU items for an entire organization that is a tenant might be stored to tenant storage area 212. A UI 230 provides a user interface and an API 232 provides an application programmer interface to system 116 resident processes to users and/or developers at user systems 112. The tenant data and the system data may be stored in various databases, such as one or more Oracle™ databases.

Application platform 118 includes an application setup mechanism 238 that supports application developers' creation and management of applications, which may be saved as metadata into tenant data storage 122 by save routines 236 for execution by subscribers as one or more tenant process spaces 204 managed by tenant management process 210 for example. Invocations to such applications may be coded using PL/SOQL 34 that provides a programming language style interface extension to API 232. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 216 for the subscriber making the invocation and executing the metadata as an application in a virtual machine.

Each application server 200 may be communicably coupled to database systems, e.g., having access to system data 125 and tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network interconnect used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, system 116 is multi-tenant, wherein system 116 handles storage of, and access to, different objects, data and applications across disparate users and organizations.

As an example of storage, one tenant might be a company that employs a sales force where each salesperson uses system 116 to manage their sales process. Thus, a user might maintain contact data, leads data, customer follow-up data, performance data, goals and progress data, etc., all applicable to that user's personal sales process (e.g., in tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 116 might also maintain system level data usable by multiple tenants or other data. Such system level data might include industry reports, news, postings, and the like that are sharable among tenants.

In certain embodiments, user systems 112 (which may be client systems) communicate with application servers 200 to request and update system-level and tenant-level data from system 116 that may require sending one or more queries to tenant data storage 122 and/or system data storage 124. System 116 (e.g., an application server 200 in system 116) automatically generates one or more SQL statements (e.g., one or more SQL queries) that are designed to access the desired information. System data storage 124 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

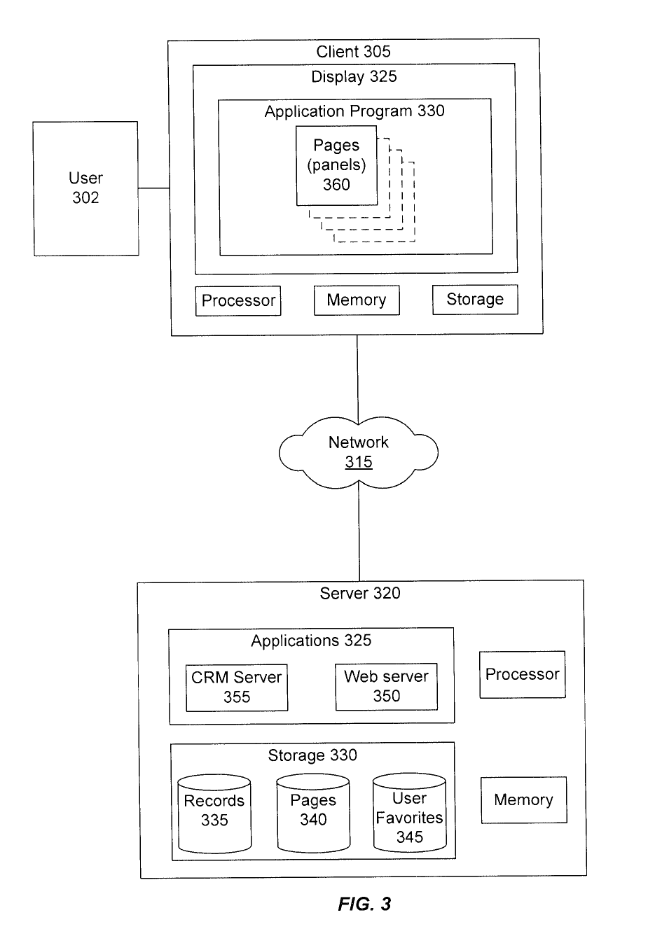

FIG. 3 shows a block diagram of a specific implementation of a system for improved navigation of a multi-page display. This system includes any number of clients such as a client 305. There is a user 302 at the client. The clients access over a network 315 a server 320. The network is as shown in FIGS. 1-2 and described above.

The client is a general purpose computer with hardware and software such as shown by user systems 112 in FIGS. 1-2 and described above. For example, client 305 includes a display 325, an application program 330, processor, memory, and storage.

In a specific embodiment, the client is a portable electronic device (e.g., tablet computer, or smartphone) having a touch-sensitive display or touchscreen. A touchscreen is an electronic visual display or screen that can detect the presence and location of a touch within the display area. For example, a user may provide input by touching (e.g., tapping, gesturing, or swiping) the display of the device with a finger or hand. Touchscreens can also sense other passive objects, such as a stylus. Some specific examples of portable electronic devices suitable for use with the present invention include the iPad® and iPhone® from Apple Inc., the Galaxy Tab from Samsung, and the HTC Desire and Nexus One® from HTC Corporation.

The application program can request, receive, and process data from a user, the server, or both. The data can be shown via the display. The application program can be a mobile browser program (e.g., Safari, Android browser, BlackBerry browser, or Internet Explorer Mobile), a mobile application or mobile app.

In a specific implementation, the mobile app is a native app. Typically, a native app is installed directly onto the client device and can be launched directly from a home page screen of the device such as by tapping on a launcher icon. The native app may be pre-installed on the client device during manufacture or may be downloaded by the user from various mobile software distribution platforms (e.g., AppExchange™ from salesforce.com, Apple App Store, Amazon Appstore, Google play, and others). A native app may be built using the device's native programming language (e.g., Java for Android by Google, Objective-C for iOS by Apple, or Visual C++ for Windows Mobile by Microsoft). A native app can be run as a standalone application (e.g., without the browser).

In another specific implementation, the mobile app is a web application or web app. A web app is typically accessed through the device's browser program. For example, a web app can be delivered over the hypertext transfer application protocol (HTTP) and can use server-side processing, client-side processing (e.g., JavaScript), or both to provide an application-like experience within a Web browser. More particularly, a web app may be written using HTML5, CSS3, JavaScript, server-side languages, a web application framework (e.g., PHP, Rails, or Python), or combinations of these.

In another specific implementation, the mobile app is a hybrid app. The hybrid app may be built using web technologies, but may be wrapped in a platform-specific shell that allows it to be installed like a native app.

The server includes components similar to the components shown in system 116 in FIGS. 1-2 and described above. For example, the server includes a processor, memory, applications 325, and storage 330. In a specific implementation, the storage includes records 335, content pages 340 that are associated with the records, and a user favorites database 345.

An application such as a Web server 350 can deliver pages (e.g., Web pages) and other data or content from the storage to application program 330. The pages may be rendered as panels to be shown on display 325. In a specific implementation, applications 325 include a customer relationship management (CRM) application or system 355. The CRM system can provide a platform to help employees collaborate, connect with customers, manage potential deals and opportunities, and provide responsive customer service.

In this specific implementation, the CRM system maintains a set of records stored in records database 335. The records can include, for example, business accounts, opportunities, leads, cases, issues, products, projects, and so forth. The records can include, be associated with, or be linked to content pages which provide detailed views of the various parameters of a particular record. A user at client 305 can access the CRM records through application program 330. Information about a specific record can be shown on the display as a stack of pages or panels 360.

For example, an opportunities record may include a first or overview page that includes a brief description of the opportunity (e.g., opportunity amount, status, or likelihood of success). The overview page may include links to other pages such as a second or contacts page that lists the people involved in the opportunity. In turn, the contacts page may include links to a third page or detailed profile page of a person. The profile page may include information such as the person's phone number, email address, supervisor, and so forth.

In a specific embodiment, these pages are shown as a stack of pages or panels 360 on the display. In this specific embodiment, upon selecting the opportunities record, the first page (e.g., opportunity overview page) is transmitted from the server to the application program and shown on the display. The user can navigate from the first page to the second page (e.g., contacts). For example, the user may tap a contacts link shown on the first page and the second page may similarly be transmitted from the server to the application program and shown on the display.

More particularly, the second page may be placed on top of the first page so that a stack including the first and second pages is formed. The user can navigate from the second page to the third page (e.g., detailed profile page) by tapping on a particular contact shown on the second page. The third page may then be similarly transmitted from the server to the application program and shown on the display. The third page may be placed on top of the stack so that the second page is now sandwiched between the third page and the first page, the first page being at the bottom of the stack. The user can navigate through the stack by using finger gestures. For example, the user can touch the surface of the display and use a swipe gesture to go from the third page (currently at the top of the stack) to the second page so that the second page is now at the top of the stack. The third page may be removed from the stack or may be placed underneath the second page in the stack.

A feature of the system allows the user to save or bookmark the sequence of pages in the stack. The saved sequence can be saved such as in favorites database 345. The user can retrieve the stack at a later time without having to again manually drill or tap through each of the pages. In this specific implementation, rather than bookmarking a single page of the stack or individually bookmarking each page of the stack, the sequence of pages, actions, or state of the stack is saved with a single user action. The system can save the order of the pages in the stack.

For example, in some cases, there may be relevant information on two or more pages of the stack. Consider the following. A user is working on an opportunity and has drilled through several pages of information related to the opportunity. A first page in a stack lists the particular products that are part of the opportunity. A second page, accessed from the first page, is on top of first page and lists the people involved in the opportunity. A third page, accessed from the second page, is on top of the second page and lists detailed profile information for a person involved on the opportunity.

The user is composing a message to send to several of the people involved in the opportunity and is using the second page (contacts listing page) and the third page (contact profile page) in order to determine who should be sent the message. The user, however, must attend a meeting or board a flight. The user can save the sequence of pages in the stack and turn the device off. When the user is ready to resume working on the message, the user can turn the device on, access the opportunity record, and retrieve the saved sequence. The user can then continue their work without having to individually reopen each of the individual pages.

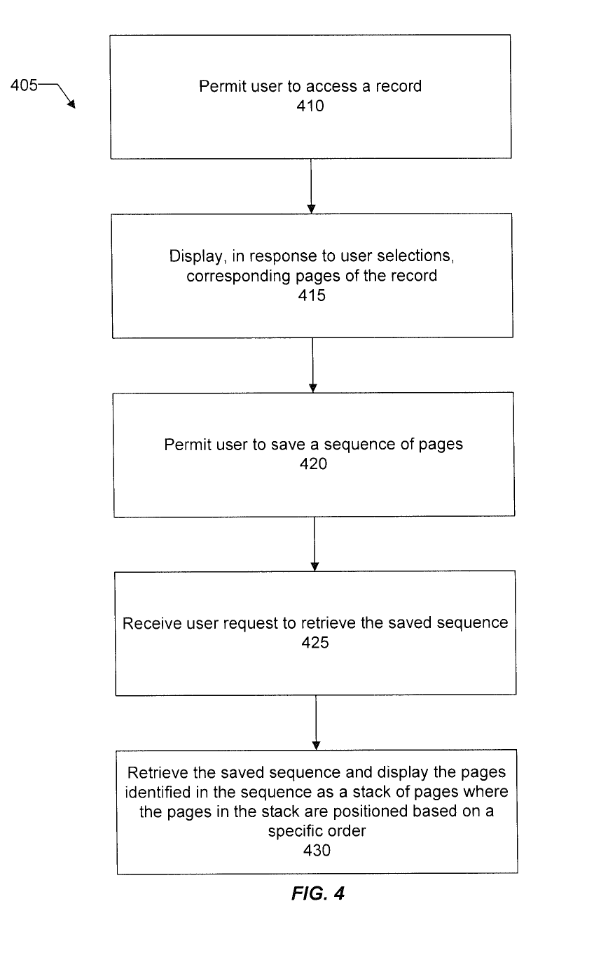

FIG. 4 shows an overall flow 405 for saving and retrieving a sequence of pages. In a step 410, the user is permitted to access a record. For example, the user may tap a particular app launcher icon on the homescreen of their device to make a data connection to the server where the records are stored. Alternatively, the user may point their browsers to the application web site such as by typing in the appropriate URL in the browser's address bar. Before the user is permitted to access the record, the user may be required to provide authentication credentials to help ensure that they are authorized to use the system or CRM system. For example, the user may be required to input a username and a password so that they can be authenticated as an employee of the organization.

In a step 415, the application program displays, in response to user selections, corresponding pages of the selected record. For example, the selected record may be a particular opportunity (e.g., potential sales deal) that the user is working on. The record may include links to various pages associated with the record. The pages may include links to other pages, and so forth (e.g., hierarchical arrangement having multiple levels of information). The pages of a record can include information such as the opportunity or deal amount, competitors, expected close date, opportunity stage (e.g., prospecting, negotiation, review, closed won, or closed lost), team members involved on the opportunity, a listing of products that the customer is interested in purchasing, quantity of product, quoted prices, list prices, product datasheets, material safety datasheets, discounts, delivery or contract terms—just to name a few examples.

In a specific implementation, as the user navigates or drills through the various levels of the record, the selected pages may be displayed as stack of pages on the display. The pages of the stack may at least partially overlap (e.g., fan or ribbon spread) or completely overlap. When pages are at least partially or completely overlapping, the user may access a previous page in the stack by making a swiping gesture over the top of the stack until the desired page is reached. For example, the user may swipe from right to left to go backwards through the stack and from left to right to go forward through the stack. Alternatively, the user may swipe from right to left to go forward through the stack and from left to right to go backwards through the stack. When pages are at least partially overlapping, the user may access a previous page by tapping on a non-overlapped portion of the desired page.

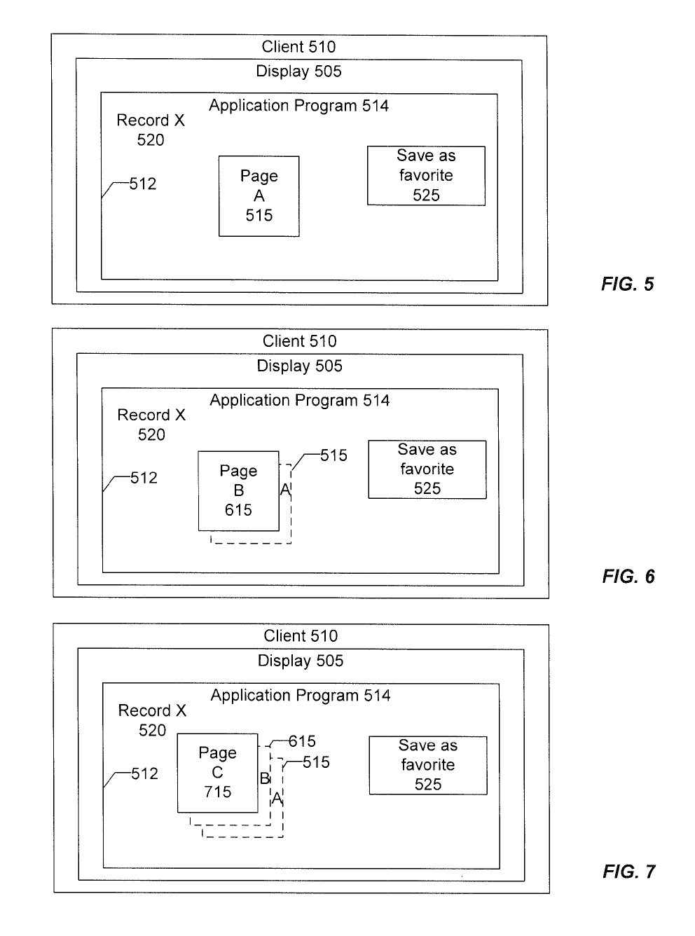

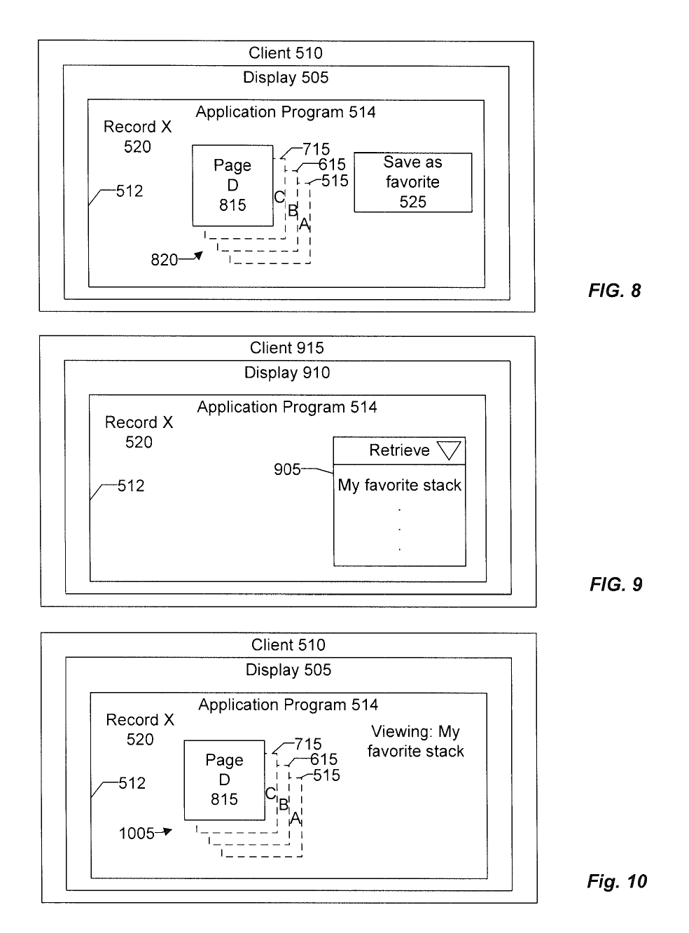

In a step 420, the user is permitted to save a sequence of pages in the stack. FIGS. 5-8 show an example the user saving a sequence of pages. FIG. 5 shows a display 505 of a client 510. The display shows a window 512 of an application program 514. The window includes a page A 515 from a record X 520 and a save button 525. As shown in FIG. 6, the user can navigate from page A to another page B 615 of the record X. For example, the user can tap a link on page A that references page B. Page B is shown in FIG. 6 as being stacked on top of page A. The user can use a similar navigation technique to access a page C 715 (FIG. 7) and a page D 815 (FIG. 8).

As shown in FIG. 8, a stack 820 includes pages D, C, B, and A. In a specific implementation, the pages in the stack are positioned based on the order in which they have been displayed. In this specific implementation, the pages are positioned reverse chronologically. The most recently displayed page is at a top of the stack followed by the next most recently displayed page, and so forth. For example, page D forms a top page of the stack and page A forms a bottom or base page of the stack. Pages C and B are between or sandwiched pages D and A. Page B is above page A. Page C is above pages A and B. Page D is above pages A, B, and C. In other words, page C is below page D. Page B is below pages C and D. Page A is below pages B, C, and D.

The user can save the sequence of pages in the stack by selecting (e.g., tapping) save button 525. Upon tapping the save button, the user may be shown a dialog box to name the sequence (e.g., “my favorite stack”). In a specific implementation, the sequence is saved at the server such as in user favorites database 345 (FIG. 3). This allows the user to access the saved sequence using a different client. In another specific implementation, the sequence is saved at the client. In this specific implementation, the pages of the sequence may likewise be saved at the client, i.e., saved locally. Saving the pages locally allows the user to work offline, i.e., without there being a data connection to the server. Changes that are made locally may synchronized or merged with data on the server when a data connection to the server is established.

Referring now to FIG. 4, in a step 425, the user may retrieve the saved sequence of pages. For example, as shown in FIG. 9, there is a dropdown list 905 shown on a display 910 of a client 915. The user has selected record X 520 in which the sequence of pages was saved or associated with. The dropdown list may include a listing of other sequences that the user may have saved for the record. The system allows the user to save multiple (i.e., two or more) sequence of pages of a record. For example, within a record, a user can save a first sequence of pages of the record. The user can save a second sequence of pages of the record, different from the first sequence. For example, a page in the first sequence may be different from a page in the second sequence. A page in the first sequence may be the same as a page in the second sequence, but the page in the first sequence may be in a different order or at a different position than the page in the second sequence.

Referring now to FIG. 4, in a step 430, the saved sequence of pages is retrieved and the pages identified in the sequence are displayed. The pages may be displayed as a stack of pages. The pages in the stack may be positioned according to a specific order such as reverse chronologically or the order in which they were saved or last displayed. For example, FIG. 10 show a state of a stack 1005 of record X 520 after the user has retrieved the save sequence. Compare the state of the stack shown in FIG. 10 with the state of the stack shown in FIG. 8; the states are the same. That is, stack 1005 includes page D followed by page C followed by page B followed by page A. The user can continue working right where the user left off in FIG. 8. Thus, with a single action, the user can save a state of the stack of pages of a record. With a single action, the user can retrieve the saved state of the stack.

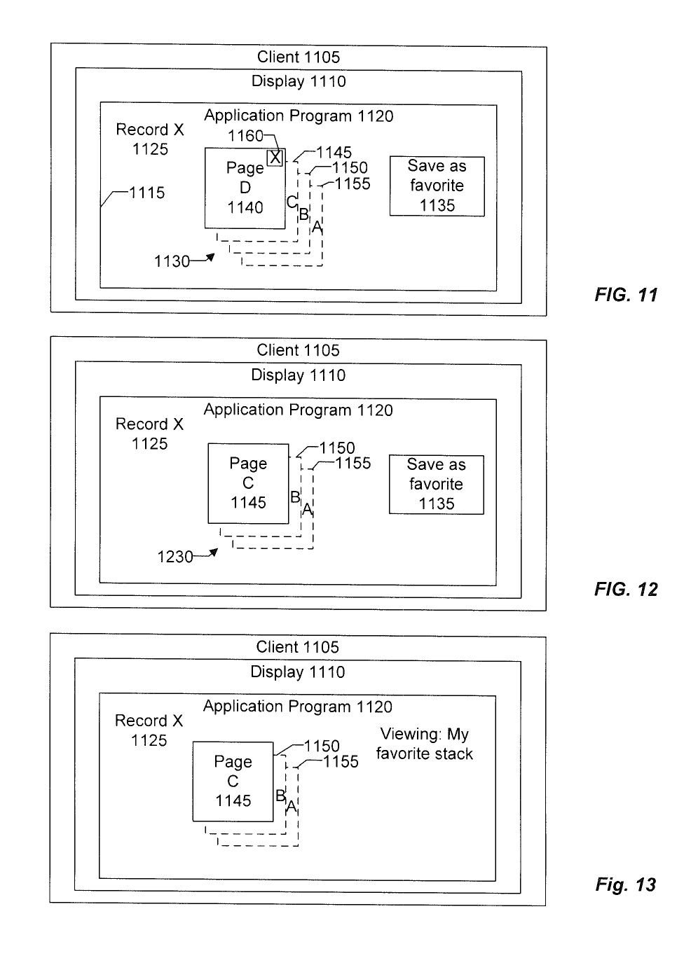

FIGS. 11-13 show another example of saving a sequence of pages. FIG. 11 shows a client 1105 that is similar to the client shown in FIGS. 5-10. For example, client 1105 includes a display 1110 that shows a window 1115 of an application program 1120. The user has used the application program to access a record X 1125 and a stack of pages 1130 that are associated with record X 1125. The application program includes a save button 1135 to save a sequence of pages in the stack.

As shown in FIG. 11, stack 1130 includes a page D 1140 followed by a page C 1145 followed by a page B 1150 followed by a page A 1155. In the example shown in FIG. 11, page D 1140 includes an icon 1160. Tapping on the icon allows the user remove the page from the stack. For example, in some cases a user may have accessed a page of the record, such as page D 1160, but does not wish to save a sequence that includes page D. So, the application program allows the user to remove page D from the stack. Thus, as shown in FIG. 12, there is a stack 1230 that does not include page D 1160. The user can tap save button 1135 to save a sequence of pages that includes pages C-A and that does not include page D.

As discussed above, the user can name the sequence (e.g., “My favorite stack.”). FIG. 13 shows the saved sequence of pages of the record having been retrieved and shown on the display. The retrieved sequence of pages includes pages C-A and does not include page D.

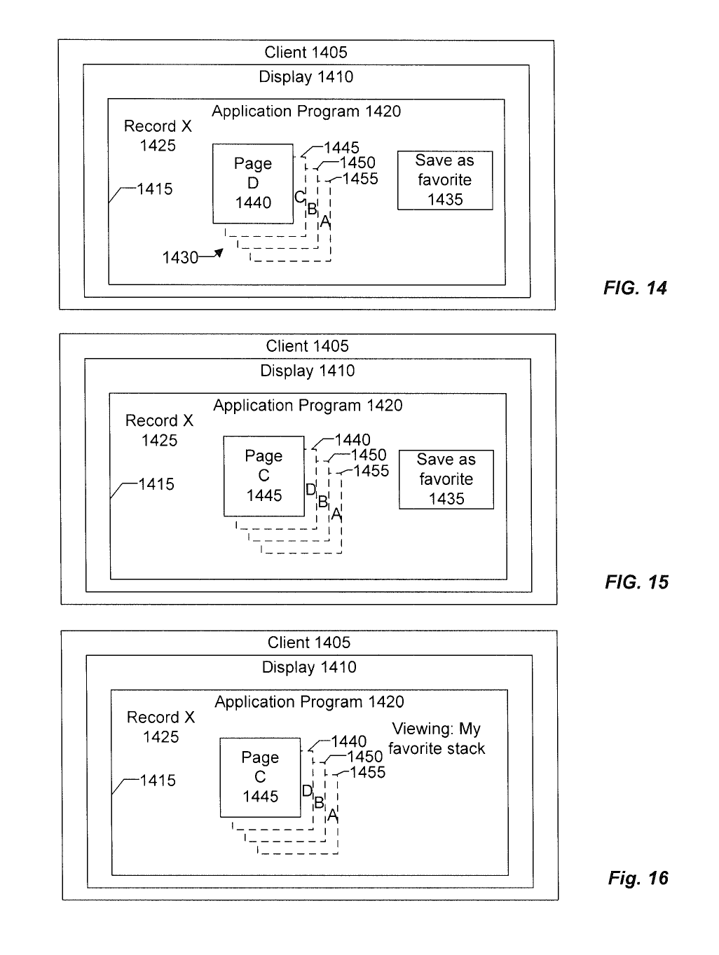

FIGS. 14-16 show another example of saving a sequence of pages. FIG. 14 shows a client 1405 that is similar to the client shown in FIGS. 5-10. For example, client 1405 includes display 1410 that shows a window 1415 of an application program 1420. The user has used the application program to access a record X 1425 and a stack of pages 1430 that are associated with record X 1425. The application program includes a save button 1435 to save a sequence of pages in the stack. The stack includes a page D 1440 followed by a page C 1445 followed by a page B 1450 followed by a page A 1455.

As discussed above, the user may access a previous page in the stack by, for example, making a swiping gesture with their finger or tapping on a non-overlapped portion of the previous page. FIG. 15 shows an example where a previous page of the stack has been brought to the top of the stack based on such a user action. That is, page C 1445 is now at the top of the stack and page D 1440 which was previously at the top of the stack (FIG. 14) has been pushed down the stack so that it is below page C.

The user can tap save button 1435 (as shown in FIG. 15) to save a sequence of pages having the order shown in FIG. 15. That is, the saved sequence will include page C 1145 followed by page D 1440 followed by page B 1450 followed by page A 1455. FIG. 16 shows an example of the saved sequence being retrieved.

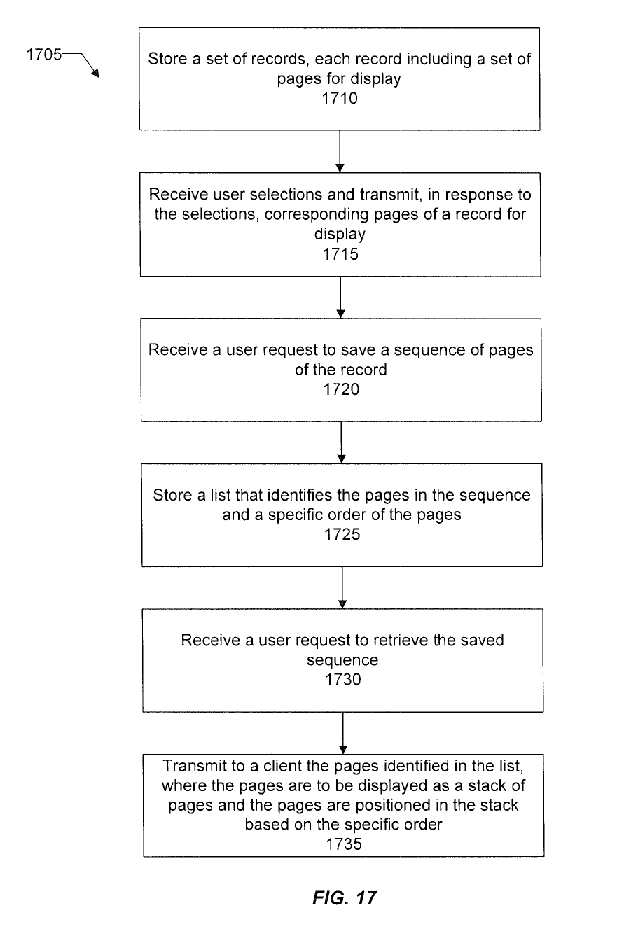

FIG. 17 shows another example of an overall flow 1705 for saving and retrieving a sequence of pages of a record. In a step 1710, a set of records is stored. Each record includes, is linked to, or is associated with a set of pages for display. In a specific implementation, the set of records is stored at the server. In another specific implementation, the set of records or at least a subset of the set of records is stored at the client. Storing records at the client allows the user to work offline. The subset of records stored at the client can be the records (e.g., accounts, or opportunities) that the user is authorized to access. Records that the user is not authorized to access may not be included in the subset of records stored at the client. This helps to conserve space (e.g., storage space) at the client.

In a step 1715, user selections within a record are received. The system transmits in response to the user selections corresponding pages of the record for display at the client. In a step 1720, the system receives a request from the user to save a sequence of pages of the record.

In a step 1725, the system stores a list that identifies the pages in the sequence and a specific order of the pages. The pages may be identified by a page identifier. In a specific implementation, the page identifier includes a uniform resource identifier (URI) or uniform resource locator (URL) that is associated with the page. It should be appreciated, however, that the page identifier can be anything that uniquely identifies or helps to identify the page. For example, the page identifier may include a compact URI (CURIE), Extensible Resource Identifier (XRI), fragment identifier, Internationalized Resource Identifier (IRI), Internet Protocol address (IP address), page title, page name, record name, characters, letters, numbers, ASCII codes, UNICODE, or combinations of these.

In a specific implementation, the specific order of the pages is the order of pages in the stack immediately before the user decides to save the sequence. The specific order of the pages may be the order of the pages in which they were last displayed (e.g., immediately prior to the sequence being saved). This allows the user to resume working right where the user left off. In another specific implementation, the saved order is different from the order in which the pages were last displayed.

In a specific implementation, the list is stored at the server. Storing the list at the server allows the user to access the saved sequence from a client different from the client used to originally access the record. In another specific implementation, the list is stored at the client. Storing the list at the client allows the user to access the saved sequence while the client is offline.

In a step 1730, the system receives a request to retrieve the saved sequence. In a step 1735, the system transmits the pages identified in the list for display at the client. In a specific implementation, the pages are to be displayed as a stack of pages where the pages in the stack are positioned based on the specific order (e.g., the order of the pages immediately prior to the user selecting the save sequence option).

In a specific implementation, the request is received at the server. The request may include, for example, an identification of the sequence of pages to be retrieved, the user name, an identification of the record associated with the save sequence of pages, or combinations of these. In response to the request, the pages may be transmitted from the server to the client.

In another specific implementation, the saved sequence of pages and the pages themselves (e.g., the page content) is stored locally at the client for offline use. In this specific implementation, the pages may be transmitted or fetched from local storage (e.g., client's hard drive) to the application program for display on the electronic screen of the client.

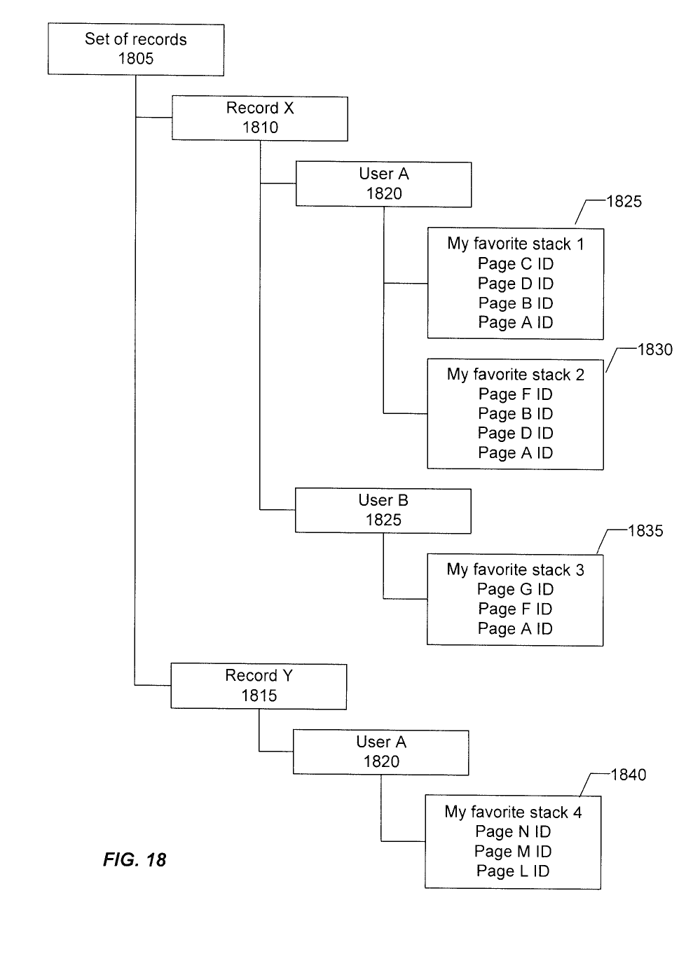

FIG. 18 shows an example of a schematic of a data structure or relationship among records, saved page sequences, and users. In the example of FIG. 18, the structure includes a set of records 1805 such as a record X 1810 and a record Y 1815. A user A 1820 and a user B 1825 are authorized to access record X. User A is also authorized to access record Y. For each record, each authorized user can save one or more sets of page sequences for the record.

For example, user A can save a first set of page sequences 1825 for record X. As shown in FIG. 18, the first set of page sequences can include page C, followed by page D, followed by page B, followed by page A. User A can save a second set of page sequences 1830 for record X. The second set of page sequences can include page F, followed by page B, followed by page D, followed by page A. The first set may be different from the second set. A page of a record identified in the first set may be different from a page of the record identified in the second set. A page of a record identified in the first set may by the same as a page of the record identified in the second set, but an order of the page in the first set may be different from an order of the page in the second set. The sets may include the same or different number of pages of the record.

User B can save a third set of page sequences 1835 for record X. The third set of page sequences may include page G, followed by page F, followed by page A. The third set may be different from or the same as a set of page sequences for user A.

In this example, user A is also authorized to access record Y. Thus, user A can save a fourth set of page sequences 1840 for record Y. A saved set of page sequences can include any number of pages from the associated record.

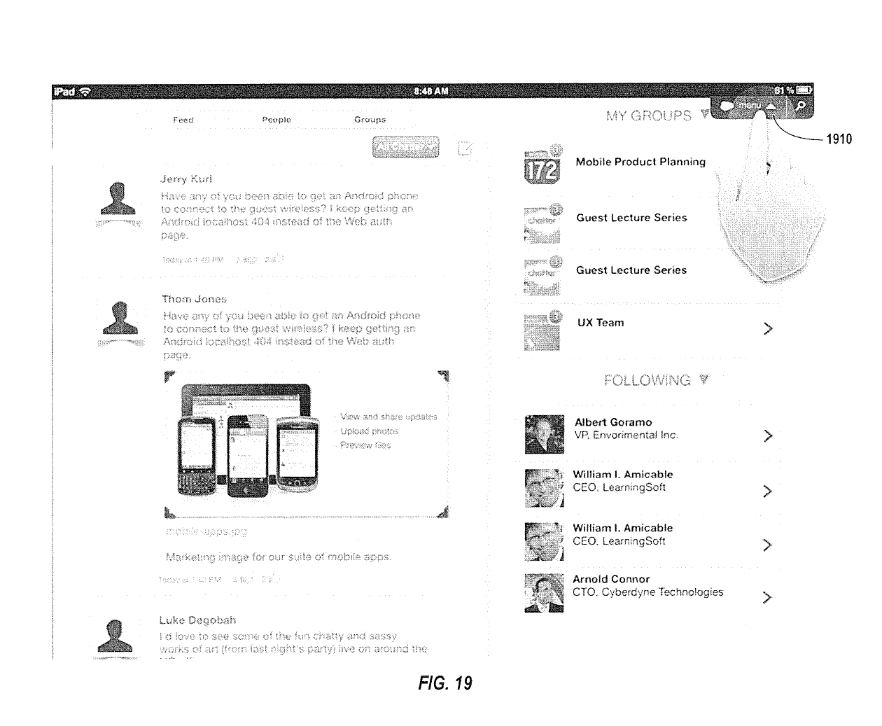

FIGS. 19-26 show some screenshots of pages displayed on electronic screen of a client to a user. The pages are from an application program provided by salesforce.com of San Francisco, Calif. It should be appreciated that these screenshots and the accompanying description are provided merely as a sample implementation. It should be understood that the invention is not limited to the specific examples and features presented. Aspects (e.g., screens, pages, or web pages) of the invention may be modified or altered as appropriate for a particular application, industry, business, or use. The application program is not limited to the specific graphical user interface (GUI) controls, widgets, objects, elements, containers, icons, windows, views, navigation, help text, and layouts shown in the screenshots. Various specific implementations may include GUI elements such as floating windows, modal windows, palette or utility windows, pop-up boxes, dialog boxes, frames, list boxes, context menus, sliders, spinners, menu bars, combo boxes, scroll bars, tabs, tree views, grid views, tooltips, balloon help, infobars, links, buttons, icons, and the like.

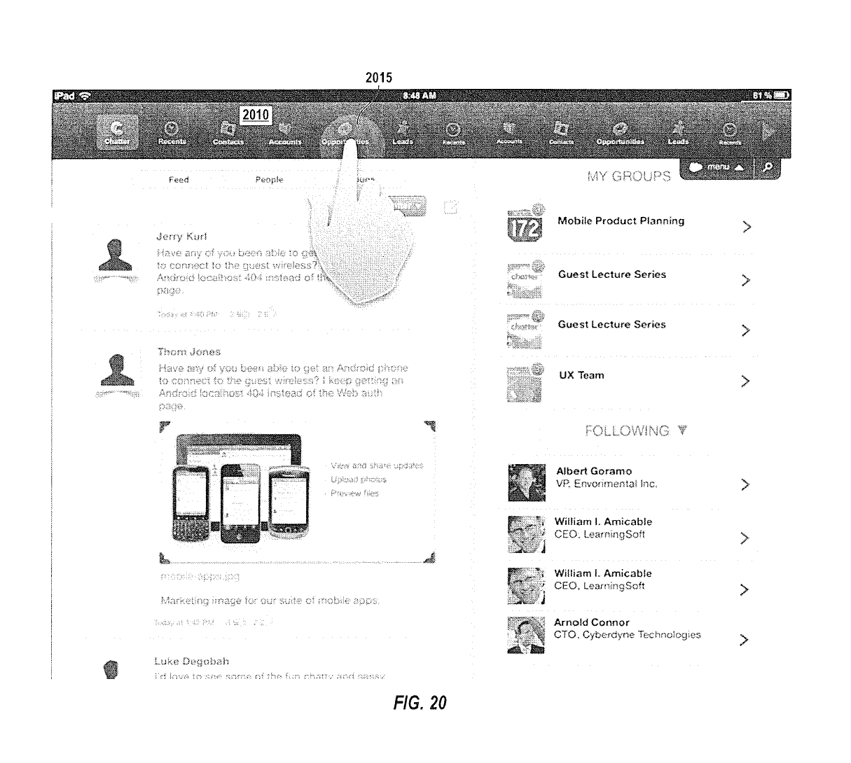

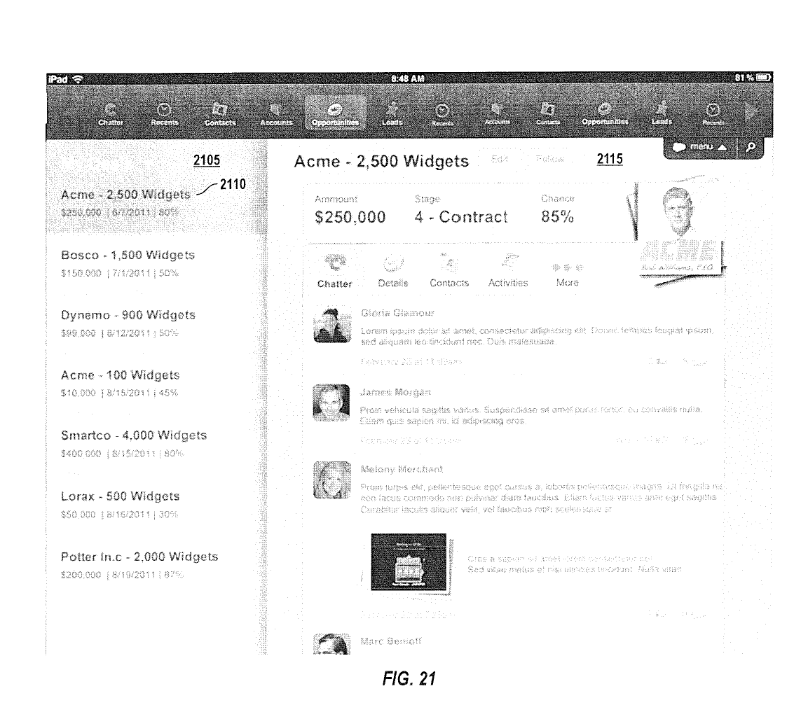

FIG. 19 shows a home page 1905 of the application program. The home page includes a menu link 1910 that can be selected to show menu options 2010 (FIG. 20). From FIG. 20, the user can select opportunities icon 2015 to view the opportunity records. FIG. 21 shows a list 2105 of opportunity records that the user is authorized to access. In this example, the user has selected an opportunity record 2110. A page 2115 displays a brief overview of the selected opportunity record and includes links to other pages.

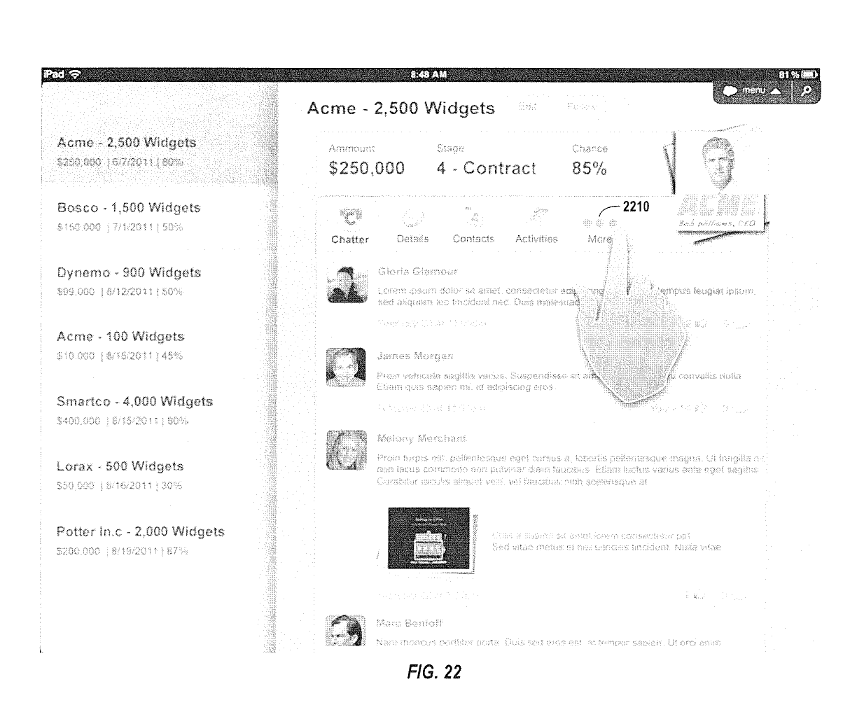

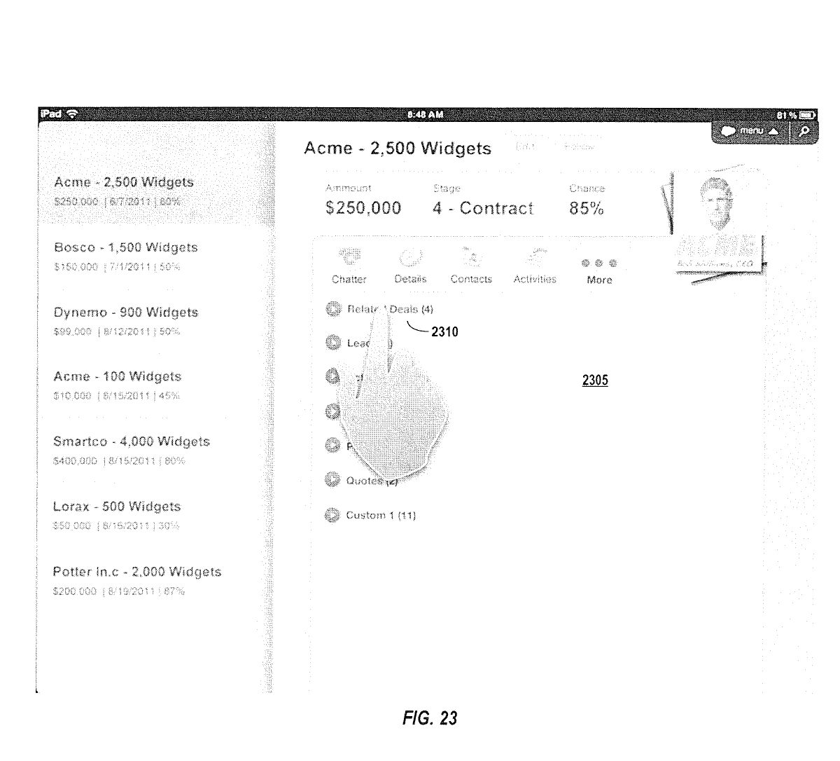

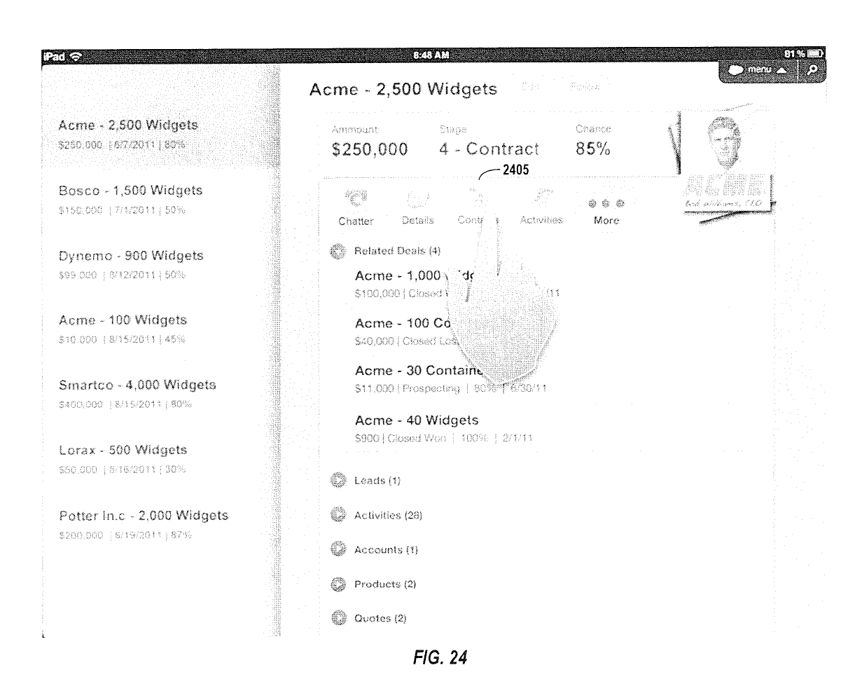

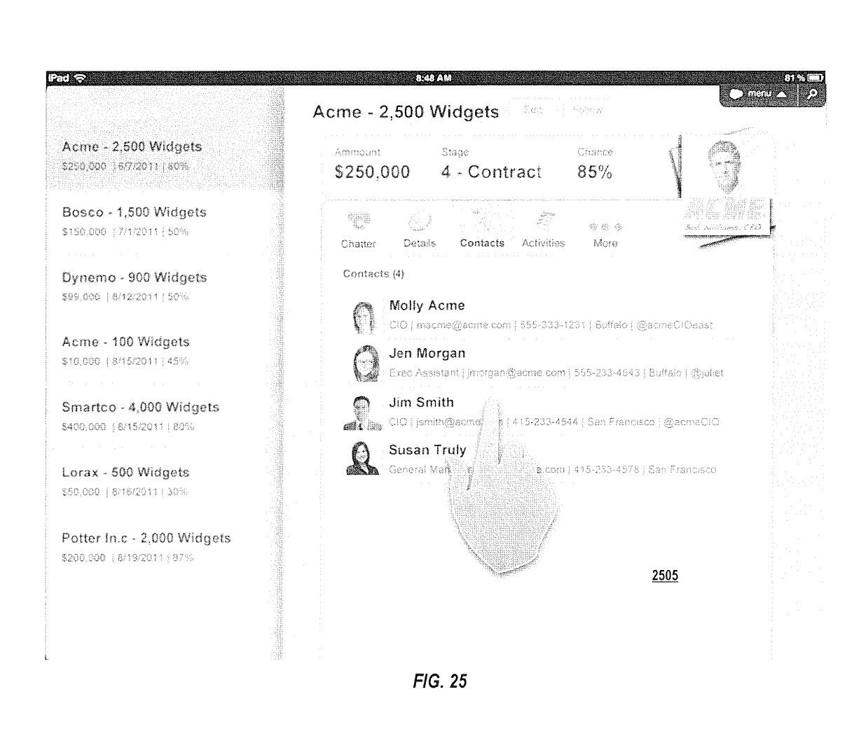

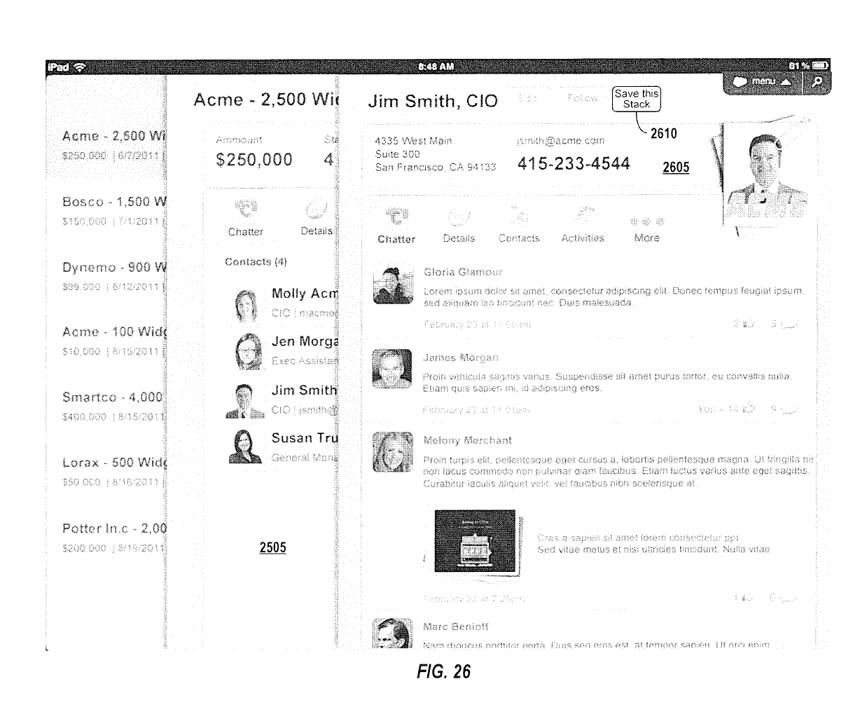

For example, the user can select a “more” button 2210 (FIG. 22) to view a page 2305 (FIG. 23) associated with the record. Page 2305 includes a listing of related lists 2310. For example, the user can select a “related deals” list item to expand the item and see deals related to the opportunity (FIG. 24). As shown in FIG. 24, the user can select a contacts button 2405 to see a contacts listing or directory page 2505 (FIG. 25). The user can select a particular contact (e.g., “Jim Smith”) to see a profile page 2605 (FIG. 26) for the contact.

As shown in FIG. 26, a stack of pages for the record includes page 2505 followed by page 2605. In this example, page 2605 partially overlaps page 2505. The user can click a save button 2610 to save the sequence of pages in the stack. The system saves the state of the stack so that the user can continue resume working where they left off at a later time.

In a specific implementation, a method includes storing a plurality of records, each record comprising a plurality of pages, receiving user access requests and transmitting, in response to the user access requests, corresponding pages of a record for display, receiving a user request to save a sequence of pages of the record that have been displayed, storing a list that identifies the pages in the sequence and an order in which the pages were last displayed, and upon receiving a request for the sequence, the request being based on having detected that the record has been selected, automatically pre-fetching, the pages identified in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method comprising:
storing a plurality of records, each record comprising a plurality of pages for display at a client;
receiving user access requests and transmitting, in response to the user access requests, corresponding pages of a record for display;
receiving a user request to save a sequence of pages of the record that have been displayed;
storing a list that identifies the pages in the sequence and an order in which the pages were displayed;
receiving a user access request for the sequence; and
transmitting, in response to the user access request for the sequence, the pages identified in the list, wherein the identified pages are to be displayed as a stack of pages, and the identified pages in the stack are positioned based on the order.

2. The method of claim 1 wherein the client is a first client and the transmitting the pages identified in the list comprises transmitting the pages to a second client, different from the first client.

3. The method of claim 1 wherein pages in the stack that have been displayed earlier are positioned below pages in the stack that have been displayed later.

4. The method of claim 1 comprising:
receiving second user access requests and transmitting, in response to the second user access requests, corresponding second pages of the record for display;
receiving a second user request to save a second sequence of second pages of the record that have been displayed;
storing a second list that identifies the second pages in the second sequence and a second order in which the second pages were displayed;
receiving a second user access request for the second sequence; and
transmitting, in response to the second user access request for the second sequence, the second pages identified in the second list, wherein the identified second pages are to be displayed as a second stack of pages, the identified second pages in the second stack are positioned based on the second order, the identified second pages are different from the identified pages, and the second order is different from the order.

5. The method of claim 1 wherein the record is a first record and the method comprises:
receiving second user access requests and transmitting, in response to the second user access requests, corresponding second pages of a second record, different from the first record, for display;
receiving a second user request to save a second sequence of second pages of the second record that have been displayed;
storing a second list that identifies the second pages in the second sequence and a second order in which the pages were displayed;
receiving a second user access request for the second sequence; and
transmitting, in response to the second user access request for the second sequence, the second pages identified in the second list, wherein the identified second pages are to be displayed as a second stack of pages, and the identified second pages in the second stack are positioned based on the second order.

6. A machine-readable medium carrying one or more sequences of instructions, which instructions, when executed by one or more processors, cause the one or more processors to carry out the steps of:
storing a plurality of records, each record comprising a plurality of pages;
permitting a user to select a record;
receiving user access requests from the user and transmitting, in response to the user access requests, corresponding pages of the record for display to the user;
receiving a request from the user to save a sequence of pages of the record that have been displayed to the user;
storing a list that identifies the pages in the sequence and an order in which the pages were last displayed to the user;
receiving a request from the user for the sequence; and
transmitting, in response to the request for the sequence, the pages identified in the list, wherein the identified pages are to be displayed as a stack of pages, and the identified pages in the stack are positioned based on the order.

7. The machine-readable medium of claim 6 comprising:
associating the list with the record.

8. The machine-readable medium of claim 6 comprising:
storing the list at a server.

9. The machine-readable medium of claim 6 wherein the user is a first user and the one or more sequences of instructions, which instructions, when executed by the one or more processors, cause the one or more processors to carry out the steps of:
permitting a second user, different from the first user, to select the record;
receiving second user access requests from the second user and transmitting, in response to the second user access requests, corresponding second pages of the record for display to the second user;
receiving a request from the second user to save a second sequence of second pages of the record that have been displayed to the second user;
storing a second list that identifies the second pages in the second sequence and a second order in which the second pages were last displayed to the second user;
receiving a request from the second user for the second sequence; and
transmitting, in response to the request for the second sequence, the second pages identified in the second list, wherein the identified second pages are to be displayed as a second stack of pages, the identified second pages in the second stack are positioned based on the second order, the identified second pages are different from the identified pages, and the second order is different from the order.

10. The machine-readable medium of claim 6 wherein the record is a first record and the one or more sequences of instructions, which instructions, when executed by the one or more processors, cause the one or more processors to carry out the steps of:
receiving second user access requests from the user and transmitting, in response to the second user access requests, corresponding second pages of a second record, different from the first record, for display to the user;
receiving a request from the user to save a second sequence of second pages of the second record that have been displayed to the user;
storing a second list that identifies the second pages in the second sequence and a second order in which the pages were last displayed to the user;
receiving a request from the user for the second sequence; and
transmitting, in response to the request for the second sequence, the second pages identified in the second list, wherein the identified second pages are to be displayed as a second stack of pages, and the identified second pages in the second stack are positioned based on the second order.

11. An apparatus comprising:
a processor; and
one or more stored sequences of instructions which, when executed by the processor, cause the processor to carry out the steps of:
storing a plurality of records, each record comprising a plurality of pages;
permitting a user to select a record;
receiving user access requests from the user and transmitting, in response to the user access requests, corresponding pages of the record for display to the user;
receiving a request from the user to save a sequence of pages of the record that have been displayed to the user;
storing a list that identifies the pages in the sequence and an order in which the pages were last displayed to the user;
receiving a request from the user for the sequence; and
transmitting, in response to the request for the sequence, the pages identified in the list, wherein the identified pages are to be displayed as a stack of pages, and the identified pages in the stack are positioned based on the order.

12. The apparatus of claim 11 wherein the one or more stored sequences of instructions which, when executed by the processor, cause the processor to carry out the steps of:
associating the list with the record.

13. The apparatus of claim 11 wherein the one or more stored sequences of instructions which, when executed by the processor, cause the processor to carry out the steps of:
storing the list at a server.

14. The apparatus of claim 11 wherein the user is a first user and the one or more stored sequences of instructions which, when executed by the processor, cause the processor to carry out the steps of:
permitting a second user, different from the first user, to select the record;
receiving second user access requests from the second user and transmitting, in response to the second user access requests, corresponding second pages of the record for display to the second user;
receiving a request from the second user to save a second sequence of second pages of the record that have been displayed to the second user;
storing a second list that identifies the second pages in the second sequence and a second order in which the second pages were last displayed to the second user;
receiving a request from the second user for the second sequence; and
transmitting, in response to the request for the second sequence, the second pages identified in the second list, wherein the identified second pages are to be displayed as a second stack of pages, the identified second pages in the second stack are positioned based on the second order, the identified second pages are different from the identified pages, and the second order is different from the order.

15. The apparatus of claim 11 wherein the record is a first record and the one or more stored sequences of instructions which, when executed by the processor, cause the processor to carry out the steps of:
receiving second user access requests from the user and transmitting, in response to the second user access requests, corresponding second pages of a second record, different from the first record, for display to the user;
receiving a request from the user to save a second sequence of second pages of the second record that have been displayed to the user;
storing a second list that identifies the second pages in the second sequence and a second order in which the pages were last displayed to the user;
receiving a request from the user for the second sequence; and
transmitting, in response to the request for the second sequence, the second pages identified in the second list, wherein the identified second pages are to be displayed as a second stack of pages, and the identified second pages in the second stack are positioned based on the second order.

16. A method for transmitting code comprising:
transmitting code to store a plurality of records, each record comprising a plurality of pages;
transmitting code to permit a user to select a record;
transmitting code to receive user access requests from the user and transmit, in response to the user access requests, corresponding pages of the record for display to the user;
transmitting code to receive a request from the user to save a sequence of pages of the record that have been displayed to the user;
transmitting code to store a list that identifies the pages in the sequence and an order in which the pages were last displayed to the user;
transmitting code to receive a request from the user for the sequence; and
transmitting code to transmit, in response to the request for the sequence, the pages identified in the list, wherein the identified pages are to be displayed as a stack of pages, and the identified pages in the stack are positioned based on the order.

17. The method of claim 16 comprising:
transmitting code to associate the list with the record.

18. The method of claim 16 comprising:
transmitting code to store the list at a server.

19. The method of claim 16 wherein the user is a first user and the method comprises:
transmitting code to permit a second user, different from the first user, to select the record;
transmitting code to receive second user access requests from the second user and transmit, in response to the second user access requests, corresponding second pages of the record for display to the second user;
transmitting code to receive a request from the second user to save a second sequence of second pages of the record that have been displayed to the second user;
transmitting code to store a second list that identifies the second pages in the second sequence and a second order in which the second pages were last displayed to the second user;
transmitting code to receive a request from the second user for the second sequence; and
transmitting code to transmit, in response to the request for the second sequence, the second pages identified in the second list, wherein the identified second pages are to be displayed as a second stack of pages, the identified second pages in the second stack are positioned based on the second order, the identified second pages are different from the identified pages, and the second order is different from the order.

20. The method of claim 16 wherein the record is a first record and the method comprises:
transmitting code to receive second user access requests from the user and transmit, in response to the second user access requests, corresponding second pages of a second record, different from the first record, for display to the user;
transmitting code to receive a request from the user to save a second sequence of second pages of the second record that have been displayed to the user;
transmitting code to store a second list that identifies the second pages in the second sequence and a second order in which the pages were last displayed to the user;
transmitting code to receive a request from the user for the second sequence; and
transmitting code to transmit, in response to the request for the second sequence, the second pages identified in the second list, wherein the identified second pages are to be displayed as a second stack of pages, and the identified second pages in the second stack are positioned based on the second order.
